(19) United States
(12) Patent Application Publication
(10) Pub. No.: US 2008/0283151 A1
(43) Pub. Date: Nov. 20, 2008

(54) Warp Stable Wood Product And Methods For Detecting The Same

(75) Inventors: Stanley L. Floyd, Enumclaw, WA (US); Chih-lin Huang, Bellevue, WA (US); Mark A. Stanish, Seattle, WA (US); John E. Jones, III, Seattle, WA (US); Susan K. Kaluzny, Seattle, WA (US); Thomas J. Taylor, Seattle, WA (US); Philip Latos, St. Albert (CA)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 11/748,886

(22) Filed: May 15, 2007

(51) Int. Cl. B23Q 27/00

(52) U.S. Cl. 144/356; 144/416

(57) ABSTRACT

A warp stable wood product and methods for detecting the same are provided. The wood product may be sorted based on its morphology, microstructure, macrostructure, and/or chemical composition properties being substantially symmetric relative to at least one or more cross-sectional centroids of the wood product, thereby imparting warp stability.

### FIELD OF THE INVENTION

This invention relates generally to a warp stable wood product and methods for detecting the same.

### BACKGROUND OF THE INVENTION

During the three year period from 1995 to 1998, solid sawn softwood lumber usage in wall framing, floor framing and roof framing dropped by 9.9%, 17.2% and 11% respectively in the United States (Eastin et al., 2001)¹. In this survey of nearly 300 builders, lumber straightness was rated the most important factor affecting buying decisions; yet of all the quality attributes surveyed, dissatisfaction with straightness was highest. It is generally recognized that unless the softwood lumber industry improves the in-service dimensional stability of its products, that industry will continue to lose market share to substitutes such as engineered wood products, steel and wood plastic composite materials. ¹Eastin, I. L., Shook, S. R., Fleishman, S. J., Material substitution in the U.S. residential construction industry, 1994 versus 1988, Forest Products Journal, Vol. 51, No. 9, 31-37.

In the United States, most softwood dimension lumber is visually graded for a variety of attributes that affect its appearance and structural properties. These attributes include knots, wane, dimension (thickness, width, and length), decay, splits and checks, slope-of-grain, and straightness (warp). Strict quality control practices overseen by third party grading agencies are in place to ensure that all lumber is “on-grade” at the point the grade is assigned. Unfortunately, the straightness of a piece is not static and can change after the piece is graded. Additional warp can develop after the piece is in the distribution channel or after it is put into service. Typical moisture content of fresh kiln dried softwood dimension lumber averages near 15% but ranges from 6% to 19%. This lumber will eventually equilibrate to a moisture ranging from 3% to 19% depending on time of year, geography and whether the application is interior or exterior (Wood Handbook)². The moisture change that occurs within an individual piece of lumber can result in a change in its straightness. Any piece of lumber is prone to develop additional “in-service” warp if its shrinkage properties are not uniform and it changes moisture after the original grade was assigned. This condition is not detectable with traditional visual grading methods. ²Wood Handbook, General Technical Report 113 (1999) Department of Agriculture, Forest Service, Forest Products Laboratory.

Recently several automated methods have been identified that are capable of estimating the warp stability of individual pieces. Examples of such methods are described in U.S. Pat. Nos. 6,293,152; 6,305,224 and 6,308,571. Although these methods teach how to use specific technologies to infer the warp stability of lumber, they do not teach the specific composition of a wood product that will provide immunity to warp distortion. This invention defines the specific physical structure and the chemical properties of a lumber product that will be warp stable in-service. This knowledge can then be used to quantify (in statistical terms) the warp stability of standard size packages of lumber. Such knowledge also has valuable implications in the development of new warp stable tree families and in the development of manufacturing methods for improving the warp stability of lumber.

Dimension lumber is generally manufactured to standard industry sizes and is generally sold in packages of standard piece count. For example, the standard package of 2×4 dimension lumber contains 208 pieces. Industry grade rules recognize the fallibility of manual lumber grading and therefore allow for a certain amount of mis-grade (usually 5%) in a standard lumber package. Today, no such error limits apply however to the warp stability of lumber in a package graded to these industry standards. Because the lumber in a single package tends to come from very similar raw material (trees from same location, age, size, etc), the number of pieces that are prone to warp can vary greatly from package to package. In some packages all of the pieces may hold grade as they dry “in-service” to lower equilibrium moisture; whereas in other packages, a large percentage of pieces may drop one or more grades when those pieces are put in-service.

Accordingly, a need exists for a method for producing warp stable lumber, i.e., lumber that will remain stable for a predicted moisture content change. A further need exists for specifying the physical structure and chemical composition necessary to ensure that virtually all pieces within a multi-piece package of lumber will maintain warp stability after future equilibration to a different moisture level.

### BRIEF DESCRIPTION OF THE DRAWINGS

The embodiments of the present invention are described in detail below with reference to the following drawings.

FIG. 1 illustrates different forms of warp;

FIG. 2 is a table of allowable warp limits for the most common grades of structural dimension lumber (nominal 2 inches);

FIG. 3 is a table of specific limits for several size products used as examples;

FIG. 4 is a table of radii of curvature in an embodiment of the present invention;

FIG. 5 is a chart of allowable gradients in lengthwise shrinkage coefficients in an embodiment of the present invention;

FIG. 6 is a chart of the typical relationship for loblolly pine (pinus taeda) fitted to the form of the Cave model.

FIG. 7 is a chart of maximum allowable microfibril angle gradients in an embodiment of the present invention;

FIG. 8 is a chart of the typical relationship between lengthwise shrinkage and acoustic velocity for loblolly pine (Pinus taeda);

FIG. 9 is a chart of maximum average acoustic velocity gradients (across width) before warp exceeds #1 grade limits in an embodiment of the present invention;

FIG. 10 is a schematic of a Tracheid-Effect (T1) measurement method in an embodiment of the present invention;

FIG. 11 is a set of charts showing the relationship between curvature of all 1 ft test segments and their T1 gradients in an embodiment of the present invention;

FIG. 12 is a chart showing the relationship between radius of curvature (reciprocal of curvature) of a 1 ft segment, its T1 gradients and the average acoustic velocity of the parent lumber piece in an embodiment of the present invention;

FIG. 13 is a schematic of a twist stability analysis method in an embodiment of the present invention;

FIG. 14 is a chart showing the relationship between the twist index and the twist change resulting from a 10% moisture loss in an embodiment of the present invention; and

FIG. 15 is a chart comparing the final warp of a sorted “warp stable” package and a mill run control group in an embodiment of the present invention.

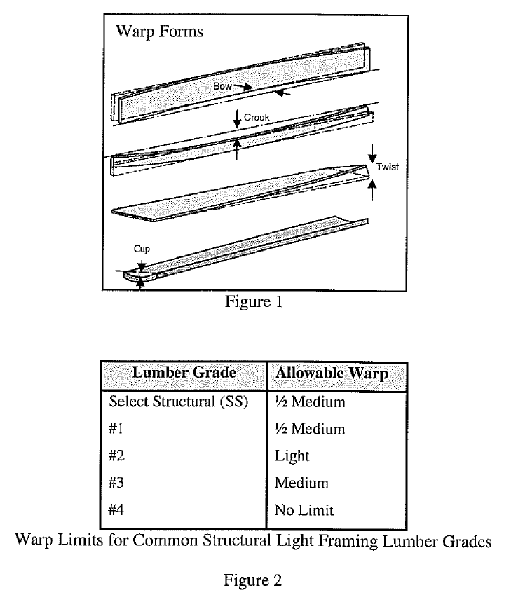

### DETAILED DESCRIPTION OF THE INVENTION

The present invention generally relates to a warp stable wood product and methods for detecting the same. The wood product may be sorted based on its morphology, microstructure, macrostructure, and/or chemical composition properties being substantially symmetric relative to at least one or more cross-sectional centroids of the wood product, thereby imparting warp stability.

The methods for determining warp stability or any of the other properties mentioned above may involve the use of single and/or multiple sensor group systems to provide qualitative and/or quantitative estimates. It has been discovered that estimates of warp/dimensional stability can be much improved when an assortment of measurements are used together, where each measurement contributes information relating to one or more variables. The measurements may be taken at one or more sections of the wood product (i.e., log or board), which may differ in size given a particular embodiment. The properties observed at the one or more sections may allow a qualitative and/or quantitative estimate of dimensional stability of a region of interest. In a first embodiment, the region of interest may be a coupon or other portion of the wood product. In another embodiment, the region of interest may overlap with one or more sections of the wood product. In another embodiment, the region of interest may be the entire wood product. In yet another embodiment, the region of interest may be the same as the one or more sections detected by the sensor group(s). In another embodiment, the region of interest does not have an overlap with the one or more sections. The dimensional stability assessed may be cup, crook, bow, twist, length stability, thickness stability, width stability, or any combination of these.

In an embodiment of the present invention, a classification algorithm may be created to classify a wood product into one of a plurality of groups or categories. The groups may be based on qualitative or quantitative characteristics. For example, in an embodiment, the categories may be different grades. Warp classification of wood products, such as boards may require inputs from one or more sensor groups detecting properties of the boards. The sensor groups may be a part of those systems previously mentioned for analyzing a wood product. The technologies for these systems are known by those skilled in the art. For example, the sensor groups may obtain moisture content measurement, electrical property measurement, structural property measurement, acousto-ultrasonic property measurement, light scatter (tracheid-effect) measurement, grain angle measurement, shape measurement, color measurement, spectral measurement and/or defect maps. Structural property measurement may measure modulus of elasticity, density, specific gravity, strength, or a combination of these. Acousto-ultrasonic property measurement measures may measure velocity and/or damping. The spectral measurement may be characterized by absorption or reflectance values over a wavelength spectrum ranging from ultraviolet through near infrared.

Using this approach, the prediction model or algorithm of the present invention may use inputs of many different resolution scales. Some examples are board average MOE, moisture content measured across the width of the board in one foot increments along the length of the board, spectroscopy data collected every inch, or laser data collected every ¼ inch.

The inputs are functions of the sensor signals and may be either quantitative or qualitative. For example, an input could be the estimated moisture content for each 12 inch lineal section of a piece of lumber, as estimated by a moisture meter. Another example is an indicator for the presence or absence of a knot in a 12 inch by 1 inch section of wood, based on a color image. Inputs may be direct sensor measurements, pre-processed signals, combined signals from several sensors or predicted measures from other sensors. Signal pre-processing may include, but is not limited to, such steps as filtering, smoothing, derivative calculations, power spectrum calculations, Fourier transforms, etc., as is well known in the art. Predicted measurements from other sensors may include, but are not limited to, shrinkage-coefficients predicted from sensors which measure the light scattering and light absorption properties of wood and used as inputs to a partial least squares, or “PLS”, prediction model.

The prediction algorithm(s) or model(s) based on the set of inputs can be derived using many techniques which include, but are not limited to, regression trees, classification trees, linear discriminant analysis, quadratic discriminant analysis, logistic regression, Partial Least Squares or other supervised learning techniques such as neural networks. There are many forms of equations or algorithms that could be used, and a general reference is Hastie, et al³. ³Hastie, T., Tibshirani, R., and Friedman, J., (2001) The Elements of Statistical Learning, Springer, New York.

Other methods for determining warp stability, wane, moisture, knot properties, or the like for a log or board are contemplated, including those described in U.S. Patent Nos. 6,308,571; 6,305,224; and 6,293,152 to Stanish et al., or any other known methods currently used at mill sites. These methods could be implemented into the process steps described above.

Each of the above methods may be utilized to locate areas of lumber, from which a wood product will be derived, which will provide symmetry of properties with respect to a centroid of the wood product. In another embodiment, each of the above methods may be utilized to detect symmetry of properties in the derived wood product. The product may then be sorted based on the type of symmetry it demonstrates. The properties may be, for example, microfibril angle, galactan, compression wood, pith location, and spiral grain.

In an embodiment, a wood product is provided. The wood product may have a cross-sectional centroid wherein at least one property is substantially symmetrical about the cross-sectional centroid of the product. The property may be selected from the group consisting of: morphology, microstructure, macrostructure, and chemical composition. In an embodiment, the microstructure property is microfibril angle. In an embodiment, the macrostructure property is grain angle. In an embodiment, the chemical composition property is a hemicellulose. In an embodiment, the morphology property is at least one of: shape, curvature, compression wood and pith location. In an embodiment, the degree of symmetry of the property is an indicator of warp potential. In an embodiment, the warp potential is at least one of: crook, bow, cup and twist.

In an embodiment, a wood product package is provided. The wood product package has a plurality of wood products wherein a performance attribute of the wood products is certified in statistical terms based on a degree to at which at least one of a morphology, microstructure, macrostructure or chemical composition property remains substantially symmetrical about a cross-sectional centroid of each of the wood products. The certified performance attribute is immunity to warp distortion.

In an embodiment, a method is provided for sorting a wood product having one or more regions of interest. The method comprises the steps of: detecting one or more properties within each region of interest wherein the detected property is at least one of: morphology, microstructure, macrostructure, and chemical composition; calculating an index of symmetry correlated to a degree to which the one or more detected properties are substantially symmetric about one or more cross-sectional centroids of one or more of the regions of interest within the wood product; and sorting the wood product into at least one of a plurality of categories based on the index of symmetry.

In an embodiment, the one or more detected properties are detected using one or more sensor groups selected from the group consisting of: moisture content measurement, electrical property measurement, structural property measurement, acousto-ultrasonic property measurement, light scatter (tracheid-effect) measurement, grain angle measurement, shape measurement, color measurement, spectral measurement and defect maps. In an embodiment, the sorting is based on one or more sensor groups in conjunction with human input. In an embodiment, the above method has the further step of: certifying a performance attribute of the wood product in statistical terms based on a degree to which at least one of the morphology, microstructure, macrostructure or chemical composition property remains substantially symmetrical about one or more of the cross-sectional centroids of the wood product.

Provided below is an example using specifications governing softwood structural dimension lumber dried to KD19 (kiln dried to maximum 19% moisture content) standards and sold in the United States. Those skilled in the art can extend these concepts to hardwood lumber, other grades of lumber, and other industry standards.

Standard grade rules governing allowable warp for softwood dimension lumber sold in the United States are defined by several agencies accredited by the American Softwood Lumber Standards Committee. Each of these rules writing agencies publish regional (species specific) grading rules conforming to American Lumber Standard (ALS) PS 20-05. Examples of such rules writing agencies include Southern Pine Inspection Bureau (Southern Yellow Pine), the West Coast Lumber Inspection Bureau (Douglas-fir, Hemlock and Hem-fir) and the National Lumber Grades Authority (Canadian SPF Lumber).

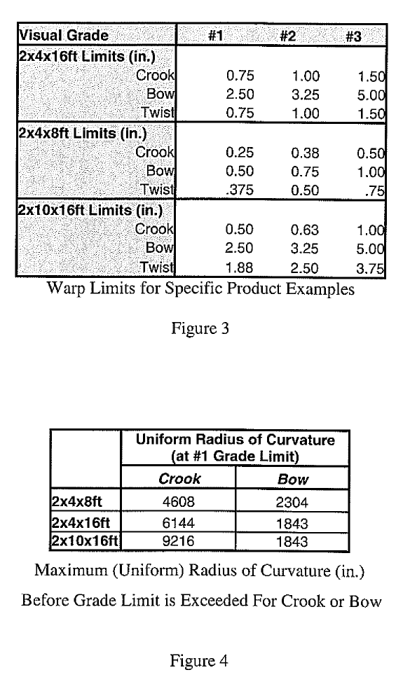

Allowable limits are set for four forms of warp (crook, bow, twist, and cup). These forms are shown in FIG. 1. Allowable warp limits for the most common grades of structural dimension lumber (nominal 2″) are shown in Error! Reference source not found.2. For purposes of this disclosure, we will define a “warp stable” piece of lumber as one which stays within #1 grade warp limits (½ of “Medium”) after the piece is put into service. FIG. 3 shows specific limits for several size products used as examples throughout this disclosure.

### Composition Necessary for Crook and Bow Stability

As taught in U.S. Pat. Nos. 6,305,224 and 6,308,571, crook and bow are caused by lengthwise shrinkage differentials that exist across the width and through the thickness of a piece of lumber, respectively. In the cases of crook and bow, it can be shown that the limiting case (least shrinkage differential before grade limit is exceeded) is a piece that has uniform curvature throughout its length. The maximum allowable radius of curvature (“ROC”) can then be calculated for this limiting case for any Thickness×Width×Length×Grade combination. FIG. 4 shows the ROC for several examples of this limiting case.

Recall, the typical average moisture content of a package of dimension structural lumber dried to KD19 standards is near 15%. This lumber will eventually equilibrate to a moisture ranging from 3% to 19% depending on time of year, geography and whether the application is interior or exterior (Wood Handbook)². Consequently, an individual piece of KD19 lumber may lose a significant amount of additional moisture between the time that it is manufactured (graded) and when it reaches its final in-service equilibrium.

U.S. Pat. No. 6,305,224 teaches that future crook and bow of a piece of lumber can be predicted from 1) its current crook and bow profile, 2) expected change in moisture content and 3) patterns of lengthwise shrinkage rate coefficients within the piece. (Lengthwise shrinkage rate coefficient (LSRC) represents the normalized length change that develops in a small element of the parent lumber after a 1% moisture content change within the element (units: in/in/% MC). An element is further defined as a piece of the parent lumber having of size ¼ parent width, ½ parent thickness and 1 ft length.)

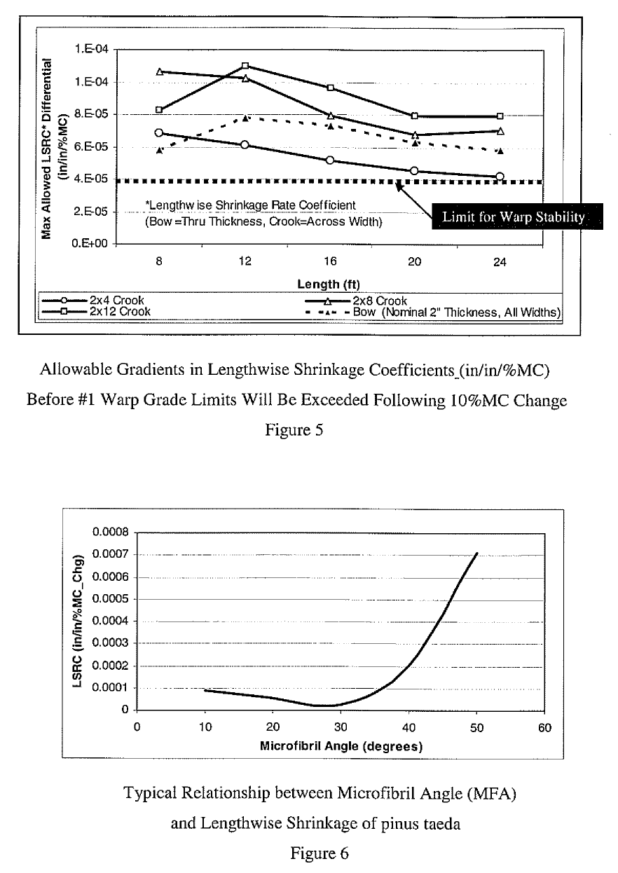

Consider the case of a piece of lumber that is straight (no warp) at the time it is manufactured. Also assume that the piece is manufactured to KD19 standards and it loses 10% moisture (on average) between manufacture and final equilibrium. In that case, if the difference in lengthwise shrinkage coefficients from one edge to the other and from one face to the other is, at all locations, below the limits shown in FIG. 5, then the (originally straight) piece will not exceed #1 grade limits at final equilibrium moisture.

In summary, a lumber product will be warp stable for crook and bow only if it is composed such that its LSRC coefficients are symmetric about the centroid of all cross sections. More specifically, if we define a warp stable piece of lumber as one whose warp change will not exceed #1 visual grade limits after 10% moisture loss, then gradients in its LSRC's must be less than approximately 4.0×10⁻⁵ in/in/% MC from face-to-face or edge-to-edge at all locations along the piece. Tolerance to these gradients increases slightly with product width.

A manufacturer has several options for evaluating individual pieces or packages of lumber to ensure that lengthwise shrinkage gradients are within target limits such as defined above. One method is to statistically sample product and measure shrinkage gradients in a laboratory using standard laboratory methods such as ASTM D-1037. Other methods might involve estimating LSRC gradients using technologies that measure correlated variables. Several examples follow.

### EXAMPLE #1

### Uniformity of Microfibril Angle as a Basis for Warp Stability

It is well known that lengthwise shrinkage is highly correlated to microfibril angle. Cave (1976)⁴ developed an empirical model for this relationship. FIG. 6 shows the typical relationship for loblolly pine (pinus taeda) fitted to the form of the Cave model. Notice that this is a highly nonlinear relationship. The slope of the curve is near zero below 35 degree MFA; and beyond that threshold, the slope of this curve increases exponentially. Therefore, the tolerance to MFA gradients is highly dependent on the average MFA of the piece. When the average MFA of a piece of lumber is small, its MFA gradients can be very large before the piece is prone to warp. On the other hand, if the average MFA is large, small gradients can render the piece highly warp prone.

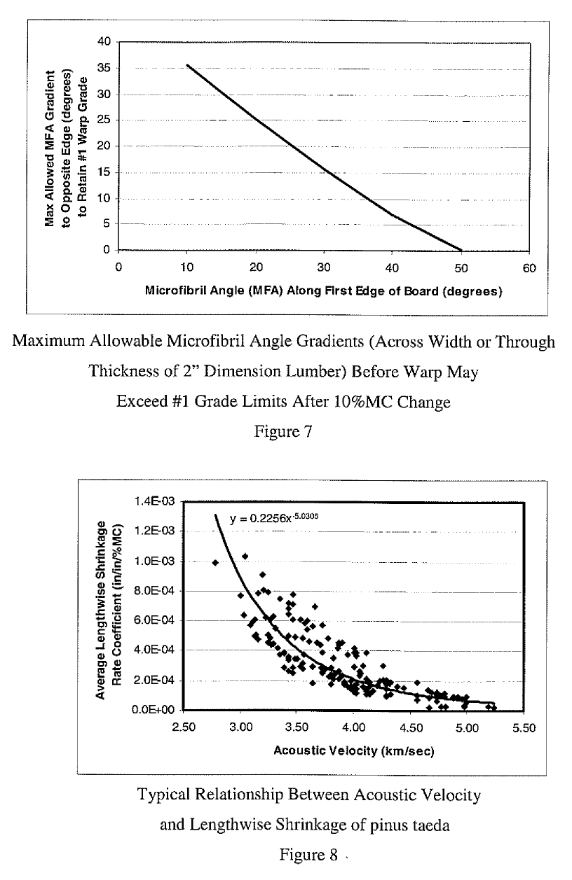

Using the relationship shown in FIG. 6 and the concepts described previously, limits can be set for allowable microfibril angle (MFA) gradients across the width or through the thickness of a piece of lumber. If these limits are not exceeded, the piece can be considered warp stable. FIG. 7 shows an example of such limits for the case where a manufacturer seeks to ensure #1 grade crook limits are retained after 10% additional moisture loss. This example is based on the criteria that shrinkage coefficients must not differ by more than 4.0×10⁻⁵ in/in/% MC from face-to-face or edge-to-edge at all locations along the piece. ⁴Cave, I. D. (1976), Modeling the structure of the softwood cell wall for computation of mechanical properties, Wood Science and Technology, 10:19-28.

This test for MFA gradients can be performed using a variety of laboratory methods, including those mentioned above, on a statistical sample basis to ensure that the warp stability of a multi-piece package of lumber is within acceptable quality control limits.

### EXAMPLE #2

### Use of Acoustic Symmetry to Infer Warp Stability

It is well known that acoustic velocity (speed at which sound travels through wood) is highly correlated to the average microfibril angle of wood. FIG. 8 shows the typical relationship between lengthwise shrinkage and acoustic velocity for loblolly pine (pinus taeda). As expected, the shape of this curve resembles the MFA-LSRC relationship shown in FIG. 6.

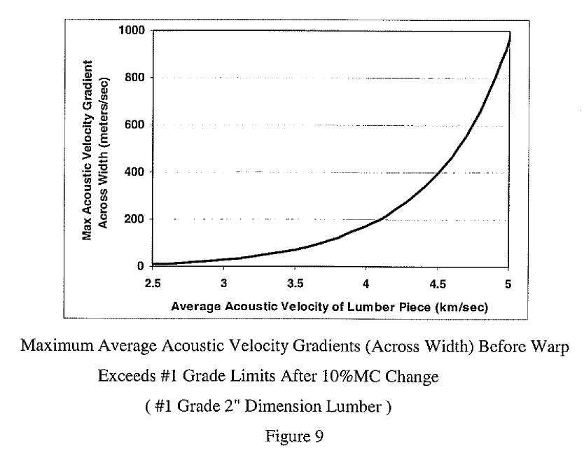

Using the relationship shown in FIG. 8 and the concepts described previously, limits can be set for allowable acoustic velocity gradients across the width or through the thickness of a piece of lumber. If these limits are not exceeded, the piece can be considered warp stable. FIG. 9 shows an example of such limits for the case where a manufacturer seeks to ensure #1 grade crook limits are retained after 10% additional moisture loss. This example is based on the criteria that shrinkage coefficients must not differ by more than 4.0×10⁻⁵ in/in/% MC from face-to-face or edge-to-edge at all locations along the piece.

This test for acoustic velocity gradients can be performed using a variety of laboratory methods, including those mentioned above, on a statistical sample basis to ensure that the warp stability of a multi-piece package of lumber is within acceptable quality control limits. Alternatively, the test can also be conducted on a lumber manufacturing line. In that case, all pieces composing a package can be quality tested, and the purity of warp stable product in the package can be tightly controlled.

### EXAMPLE #3

### Use of Light Scatter Symmetry to Infer Warp Stability

It is known that when a spot of light illuminates an unfinished wooden surface, the wood fibers distort the pattern of reflected light in such a way that the reflected shape looks different than the incident shape. The degree to which the light spot is distorted by the wood is an indicator of the lengthwise shrinkage properties of the wood at that location (Nystrom et al., 1999)⁵. This “tracheid effect” measurement (referred to as “T1 measurement”) is taught in U.S. Pat. No. 3,976,384. ⁵Nystrom, J.; Hagman, O.; Methods for detecting compression wood in green and dry conditions., Proceedings of the SPIE—The International Society for Optical Engineering (1999) vol. 3826, p. 287-94.

An experiment was conducted to verify that a T1 measurement can be used to identify pieces of lumber that are composed of matter having shrinkage gradients exceeding acceptable limits for warp stability such as those defined in FIG. 5. In this experiment, 198 2 inch×4 inch lumber samples (8 ft long) were scanned using a T1 scanner as implemented in a GradeScan® autograder manufactured by Lucidyne Technologies Inc. of Corvallis, Oreg. Each reported T1 data value represents the difference in light level intensities (8-bit grayscale value) measured between two fixed radial distances from the centroid location of an incident laser spot. The GradeScan® autograder reports at a spatial density of approximately 50 measurements per square inch of lumber surface area).

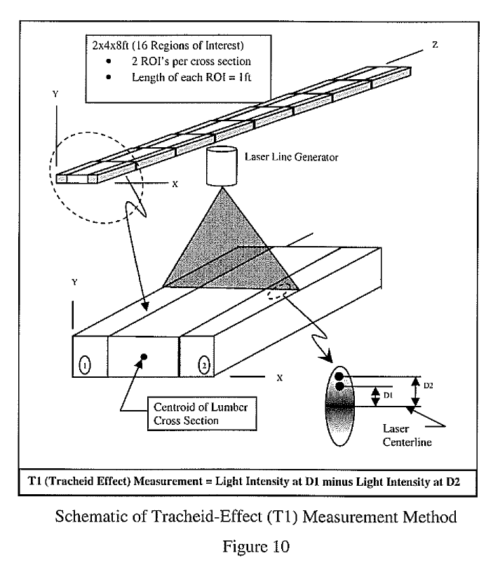

T1 scan data as described above was acquired on both wide faces of each piece of test lumber and was then averaged for 16 regions of interest within each piece of lumber (where a region of interest represented a volume of wood located nearest the edges of the board and having a size equal to full thickness×¼ width×⅛ length). Average acoustic velocity within each full size (parent) piece was also measured and all pieces were then conditioned (dried) from an initial moisture content near 15% down to an equilibrium moisture content (EMC) of approximately 5%. The crook profiles (2-dimensional shape) of all pieces were measured at the final EMC; and from these profile measurements the curvature (inverse of radius of curvature) was calculated for each 1 foot segment of board length. For each 1-ft segment of board length, the difference in average T1 measurements between opposing outermost regions of interest was then analyzed for relationship to crook curvature. The measurement scheme is shown in FIG. 10.

Following the previous discussion, the spatial patterns of the T1 measurements are expected to correlate with lumber curvature (crook and bow) because of their correlation with microfibril angle patterns. Furthermore, lumber having low acoustic velocity is expected to be more sensitive to these spatial patterns (more prone to develop curvature) than lumber having high acoustic velocity. All data described above was analyzed to test these hypotheses.

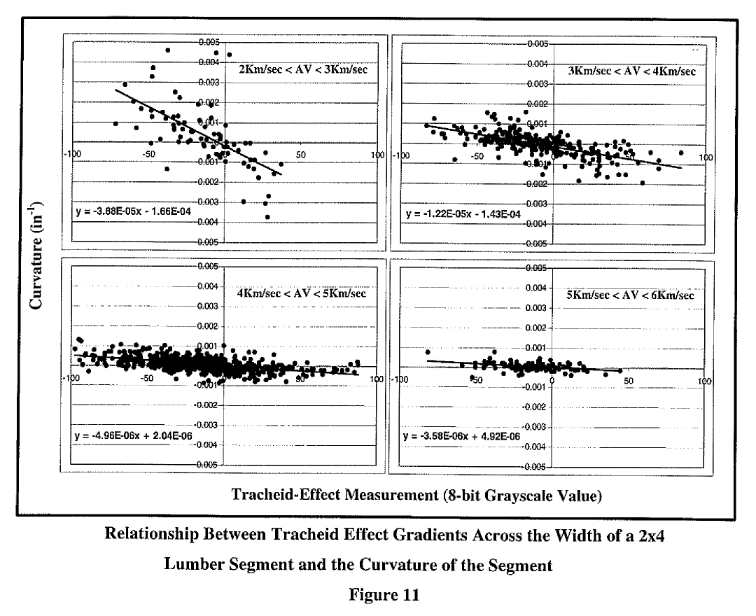

FIG. 11 shows the relationship between curvature of all 1 ft test segments and their T1 gradients (difference in average T1 values measured between two regions of interest located adjacent to the narrow edges of these segments). As expected, crook curvature increases as the magnitude of the T1 gradient increases; and the sensitivity to these T1 gradients is highest for pieces having low acoustic velocity.

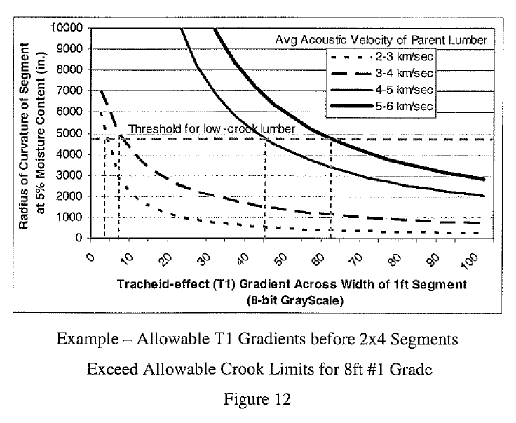

The relationships shown in FIG. 11 can be used as a basis for identifying segments whose composition is likely to develop unacceptable crook curvature if further dried. FIG. 12 shows the relationship between radius of curvature (reciprocal of curvature) of a 1 foot segment, its T1 gradients and the average acoustic velocity of the parent lumber piece. In this example a threshold ROC is shown—corresponding to allowable #1 grade warp limit for 2×4×8 ft #1 grade lumber. In this example, maximum allowable T1 gradients across the width vary from 1 grayscale unit to 66 units depending on the acoustic velocity of the parent board. Under these criteria, boards having acoustic velocity below 4 km/sec have virtually no tolerance for T1 gradients across their widths. On the other hand, boards having higher acoustic velocities can tolerate significant (and quantifiable) T1 gradients before the board is considered unstable with respect to crook.

This test for T1 gradients can be conducted within a lumber manufacturing line. In that case, all pieces composing a package can be quality tested, and the purity of warp stable product in the package can be tightly controlled.

### Composition Necessary for Twist Stability

It has been shown that when lumber dries without restraint it can develop twist at any cross section where spiral grain patterns exist (Booker, 2005)⁶. Although these teachings provide a theoretical framework for understanding how spiral grain and volumetric shrinkage interact to cause lumber to twist, they do not teach the specific physical and chemical composition of lumber that will provide stability to twist distortion. ⁶Booker, R. E.; Geometric model to predict twist in unrestrained boards, Wood Science and Technology (2005) 39: 269-289.

### EXAMPLE #4

### Symmetry of Grain Angle as a Basis for Warp Stability

An experiment was conducted on freshly manufactured 2×10×16 ft dimension lumber having an average moisture content of approximately 15%. The lumber was then further dried to approximately 5% moisture. Twist measurements were taken on all pieces at their initial and final moisture states.

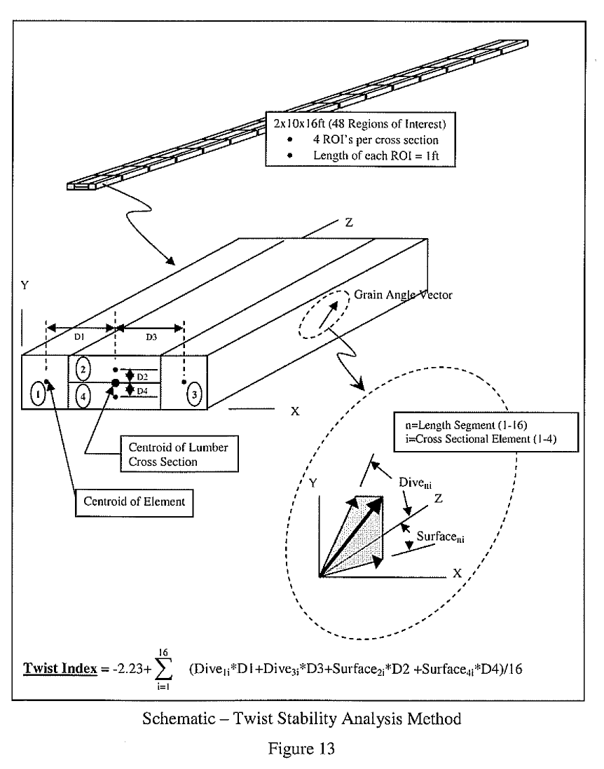

Three-dimensional grain angle vector measurements were taken on the wide faces of all pieces using a laser based technique described in U.S. Pat. No. 4,606,645. Each measurement consisted of both the surface component (grain angle projected onto the plane of the wide surface) and the dive component (grain angle perpendicular to the plane of the wide surface) of the grain vector. Measurements were taken at a spatial density of approximately 50 measurements per square inch of surface area and then averaged over larger regions of interest (similar to Example #3). In this case each full length piece was divided into 48 regions of interest and a twist index was calculated for each piece based on the dive and surface components of grain angle for all regions of interest. Details and definitions related to the analysis method are shown schematically in FIG. 13.

Collected data was analyzed with the objective of identifying patterns of grain angle composition that result in immunity to twist distortion. For this analysis, a twist index was defined for each piece as shown in FIG. 13. This index is based essentially on the differential between the surface grain angles of the two wide faces and the differential between the dive angles at the edges of the piece.

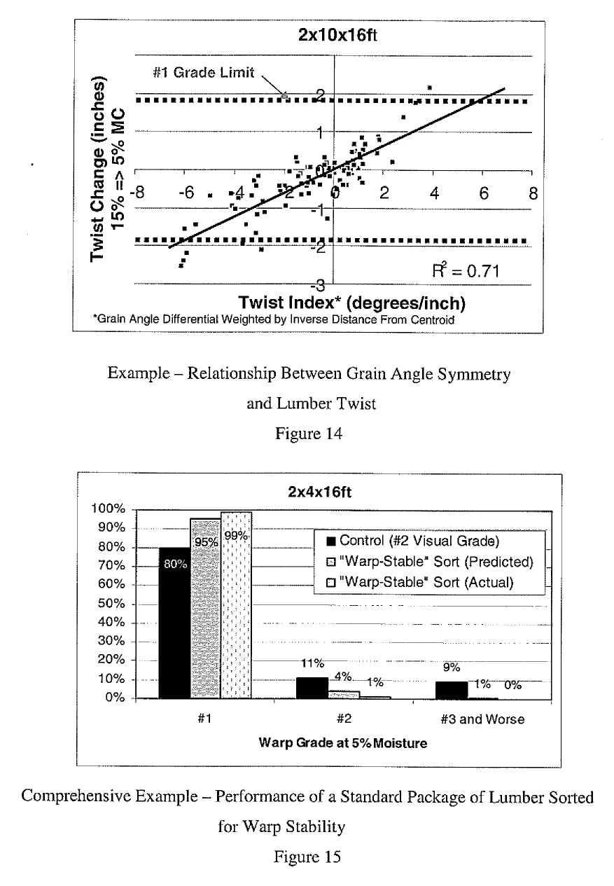

FIG. 14 shows the relationship between the above defined twist index and the twist change resulting from a 10% moisture loss. Similar relationships were observed for other size products.

Using the relationship shown in FIG. 6 and the concepts described previously, limits can be set for allowable grain angle asymmetry across the width or through the thickness of a piece of lumber. If these limits are not exceeded, the piece can be considered twist stable. FIG. 14 shows an example of such limits for the case where a manufacturer seeks to ensure #1 grade crook limits are retained after 10% additional moisture loss. In that case, the twist index must not exceed 6 degrees per inch.

This test for grain pattern symmetry can be conducted within a lumber manufacturing line. In that case, all pieces composing a package can be quality tested, and the purity of warp stable product in a standard multi-piece package can be tightly controlled.

Similar quality control methods can be developed based on other variables known to correlate with lumber twist, such as, for example, longitudinal and tangential shrinkage gradients.

### Quality Control Methods to Ensure Warp Stability Performance of Standard Lumber Packages

The examples presented above describe a range of methods that can be used to identify individual pieces of lumber whose microstructure and chemistry composition provide immunity against the development of unacceptable future warp. Similar quality control methods can be developed based on other variables known to correlate with lumber warp. These include any measurable properties that correlate to patterns of shrinkage (longitudinal, radial, and tangential) and grain angle such as microfibril angle, acoustic, hemicellulose composition, and T1 effect.

Since lumber is generally sold in multi-piece packages, a quantitative measure of warp stability of a standard multi-piece package is desired by lumber manufacturers and their customers where that is the unit of sale. Using the above collection of methods, an experiment was conducted to determine the accuracy to which the warp grade of all pieces within a standard package of 2×4's can be assured if all pieces within the package were to subsequently dry in-service to 5% moisture content. In this experiment, a random sample of #2 grade 2×4×16 ft southern yellow pine was taken. From this sample, a standard size package (208 pieces) of lumber was sorted based on the criteria that 95% of those pieces were expected to stay within #1 grade warp limits after drying in-service to as low as 5% moisture content. A standard sized package of mill run lumber was also collected as a control. All sampled lumber (including that in the “warp stable” sorted package) was then dried to 5% moisture content and its warp grade was measured at that condition. Comparisons were then made between the final warp of the sorted “warp stable” package and mill run control.

Results are shown in FIG. 15. In this example, 9% of the control product fell below #2 grade for warp when dried to 5% moisture. By comparison, none of the “warp-stable” sorted product fell below #2 grade. In fact, 99% of that sort held #1 grade warp at 5% moisture. The actual warp stability performance of the sorted product was very close to the predicted levels.

In the above examples, limits of asymmetry in a wood property required for warp stability are determined via associations between the wood properly and length-wise shrinkage. For ease of illustration, it has been assumed that these associations are perfect, in the sense that length-wise shrinkage or shrinkage gradients are perfectly predicted by the wood property. In practice the relationships are not perfect, as illustrated in the accompanying figures, and the limit of asymmetry in a wood property must be adjusted for this prediction en-or. From the examples disclosed herein it has been demonstrated that a desired composition of a package of lumber can be defined; and if that composition is achieved, the warp stability of pieces contained within the package can be assured in statistical terms. Furthermore, it has been demonstrated that a variety of methods can be used to ensure the desired composition.

While the embodiments of the invention have been illustrated and described, as noted above, many changes can be made without departing from the spirit and scope of the invention. Accordingly, the scope of the invention is not limited by the disclosure of the embodiments. Instead, the invention should be determined entirely by reference to the claims that follow.

What is claimed is:

1. A wood product having a cross-sectional centroid wherein at least one property is substantially symmetrical about the cross-sectional centroid of the product wherein the property is selected from the group consisting of: morphology, microstructure, macrostructure, and chemical composition.

2. The wood product of claim 1 wherein the microstructure property is microfibril angle.

3. The wood product of claim 1 wherein the macrostructure property is grain angle.

4. The wood product of claim 1 wherein the chemical composition property is a hemicellulose.

5. The wood product of claim 1 wherein the morphology property is at least one of: shape, curvature, compression wood and pith location.

6. The wood product of claim 1 wherein degree of symmetry of the property is an indicator of warp potential.

7. The wood product of claim 6 wherein the warp potential is at least one of: crook, bow, cup and twist.

8. A wood product package comprising:
a plurality of wood products wherein a performance attribute of the wood products is certified in statistical terms based on a degree to at which at least one of a morphology, microstructure, macrostructure or chemical composition property remains substantially symmetrical about a cross-sectional centroid of each of the wood products.

9. The wood product package of claim 8 wherein the certified performance attribute is immunity to warp distortion.

10. The wood product package of claim 8 wherein the microstructure property is microfibril angle.

11. The wood product package of claim 8 wherein the macrostructure property is grain angle.

12. The wood product package of claim 8 wherein the chemical composition property is a hemicellulose.

13. The wood product package of claim 8 wherein the morphology property is at least one of: shape, curvature, compression wood and pith location.

14. The wood product package of claim 8 wherein the performance attribute is certified based on a change in moisture content.

15. A method for sorting a wood product comprised of one or more regions of interest, the method comprising the steps of:
detecting one or more properties within each region of interest wherein the detected property is at least one of: morphology, microstructure, macrostructure, and chemical composition;
calculating an index of symmetry correlated to a degree to which the one or more detected properties are substantially symmetric about one or more cross-sectional centroids of one or more of the regions of interest within the wood product; and
sorting the wood product into at least one of a plurality of categories based on the index of symmetry.

16. The method of claim 15 wherein the one or more detected properties are detected using one or more sensor groups selected from the group consisting of: moisture content measurement, electrical property measurement, structural property measurement, acousto-ultrasonic property measurement, light scatter (tracheid-effect) measurement, grain angle measurement, shape measurement, color measurement, spectral measurement and defect maps.

17. The method of claim 15 wherein the sorting is based on one or more sensor groups in conjunction with human input.

18. The method of claim 15 further comprising the step of:
certifying a performance attribute of the wood product in statistical terms based on a degree to which at least one of the morphology, microstructure, macrostructure or chemical composition property remains substantially symmetrical about one or more of the cross-sectional centroids of the wood product.

19. The method of claim 15 wherein the microstructure property is microfibril angle.

20. The method of claim 15 wherein the macrostructure property is grain angle.

21. The method of claim 15 wherein the chemical composition property is a hemicellulose.

22. The method of claim 15 wherein the morphology property is at least one of: shape, curvature, compression wood and pith location.
